(19) United States
(12) Patent Application Publication
(10) Pub. No.: US 2016/0264095 A1
(43) Pub. Date: Sep. 15, 2016

(54) SEATBELT BUCKLE PRESENTER

(71) Applicant: GM GLOBAL TECHNOLOGY OPERATIONS LLC, Detroit, MI (US)

(72) Inventors: Richard L. Bruderick, Auburn Hills, MI (US); Andre A. Saleh, Troy, MI (US)

(73) Assignee: GM GLOBAL TECHNOLOGY OPERATIONS LLC, Detroit, MI (US)

(21) Appl. No.: 14/643,348

(22) Filed: Mar. 10, 2015

(51) Int. Cl. B60R 22/20; B60R 22/22; B60R 22/26; B60R 22/00

(52) U.S. Cl. CPC B60R 22/20; B60R 22/00; B60R 22/22; B60R 22/26; B60R 2022/1806

(57) ABSTRACT

A seatbelt system for a vehicle having a vehicle structure and a seat operatively connected to the vehicle structure includes first and second anchors. Each of the first and second anchors is connected to the vehicle structure. The system also includes complementary first and second buckle elements. The first buckle element is configured to engage the second buckle element and fasten thereto. The system additionally includes a first belt connecting the first anchor to the first buckle element and a second belt connecting the second buckle element to the second anchor. The system additionally includes a buckle presenter connecting the second buckle element to the second anchor and having a form configured to present the second buckle element to a user of the seatbelt system. The form of the buckle presenter varies under an applied force and is recovered when the force is removed.

### TECHNICAL FIELD

The present disclosure relates to a presenter of a seatbelt buckle in a vehicle.

### BACKGROUND

Vehicles are typically provided with seats designed to accommodate the operator and passenger(s) of the vehicle. Frequently, such seats are configured to shift inside the vehicle as well as recline in order to enhance passenger comfort and be moved out of the way to generate useful space for transporting cargo. Some vehicle seats employ mechanisms that permit the seats to fold and/or be removed from the subject vehicle to further improve the versatility of the subject vehicle.

Most vehicle seats work together with seatbelts configured to restrain the vehicle's operator and passengers. Typically, seatbelts are configured as flexible bands or straps and employ buckles to fasten two ends of the seatbelt around the vehicle occupant. In some vehicles seatbelts are attached directly to vehicle body structure, while in other vehicles seatbelts are incorporated into structures of the seats.

### SUMMARY

A seatbelt system for a vehicle having a vehicle structure and a seat operatively connected to the vehicle structure includes a first anchor and a second anchor. Each of the first and second anchors is connected to the vehicle structure. The seatbelt system also includes a first buckle element and a complementary second buckle element. The first buckle element is configured to engage the second buckle element and fasten thereto. The seatbelt system additionally includes a first belt connecting the first anchor to the first buckle element and a second belt connecting the second buckle element to the second anchor. The seatbelt system additionally includes a buckle presenter connecting the second buckle element to the second anchor and having a free form configured to present the second buckle element to a user of the seatbelt system. The form or shape of the buckle presenter varies under an applied force and is recovered when the force is removed.

The buckle presenter may include a first end configured to be fixedly retained by the second anchor and a second end configured to be fixedly retained by the second buckle element.

The first end of the buckle presenter may include one of a hook and a loop.

The second end of the buckle presenter may include a “T” shape.

The buckle presenter may be constructed from a spring steel wire.

The spring steel wire may be a single continuous wire segment.

The buckle presenter may be integrated into the second belt.

The buckle presenter and the second belt may be separate, i.e., stand-alone and operating independently, components connected solely at the second buckle element and the second anchor.

The buckle presenter may support the second buckle element in horizontal and vertical planes and hold the second buckle element at a predetermined distance from the second anchor.

The first belt may be a retractable combination lap-shoulder belt and the second belt may have a fixed length.

A vehicle having the disclosed seatbelt system is also provided.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a perspective schematic view of a seatbelt system including a seat mounted in a vehicle and having a seatbelt system with a buckle presenter according to the disclosure.

FIG. 2 is a close-up schematic side view of the seat shown in FIG. 1, illustrating the seat positioned in an upright state and the buckle presenter in a freed up state to thereby present the second buckle element for usage by an operator.

FIG. 3 is a close-up schematic side view of the seat shown in FIG. 1, illustrating the buckle presenter being compressed by the seat positioned in a folded state.

FIG. 4 is a close-up schematic side view of an alternative embodiment of the seat shown in FIG. 1, illustrating the seat positioned in an upright state and the buckle presenter in a freed up state to thereby present the second buckle element for usage by an operator.

FIG. 5 is a close-up schematic side view of the seat shown in FIG. 4, illustrating the buckle presenter being compressed by the seat positioned in a folded state.

FIG. 6 is a close-up perspective view of the buckle presenter shown in FIGS. 1-5 according to an embodiment of the disclosure.

FIG. 7 is a close-up perspective view of the buckle presenter shown in FIGS. 1-5 according to another embodiment of the disclosure.

### DETAILED DESCRIPTION

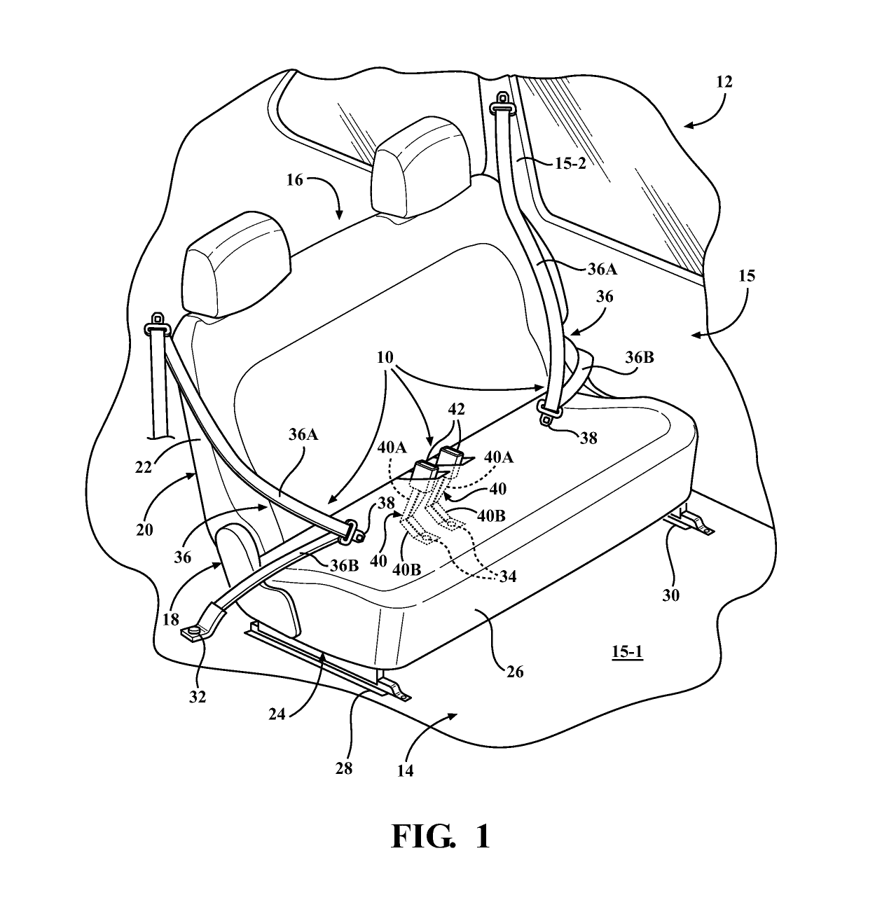

Referring to the drawings, wherein like reference numbers refer to like components, FIG. 1 shows a perspective view of a seatbelt system 10 positioned inside a vehicle 12 and operatively connected to a vehicle structure 14. The vehicle 12 may have any body style configuration, for example a sedan, a wagon, or a van, and includes a passenger compartment 15. The vehicle 12 includes a seat 16 positioned inside the passenger compartment 15 and operatively connected to the vehicle structure 14. As will be described in detail below, the seatbelt system 10 is intended to interact with the seat 16 for the purpose of securing an occupant of the vehicle 12.

The seat 16 includes a seat frame 18. The seat frame 18 includes a first seat structure 20 that is configured to support a seatback 22. The seat frame 18 also includes a second seat structure 24 that is configured to support a cushion 26. The first seat structure 20 is pivotably attached to the second seat structure 24 to accommodate an occupant of the vehicle 12. The second seat structure 24 includes a first track 28 and a second track 30. As shown, the seat 16 is slidably mounted to the vehicle structure 14 via the first track 28 and the second track 30.

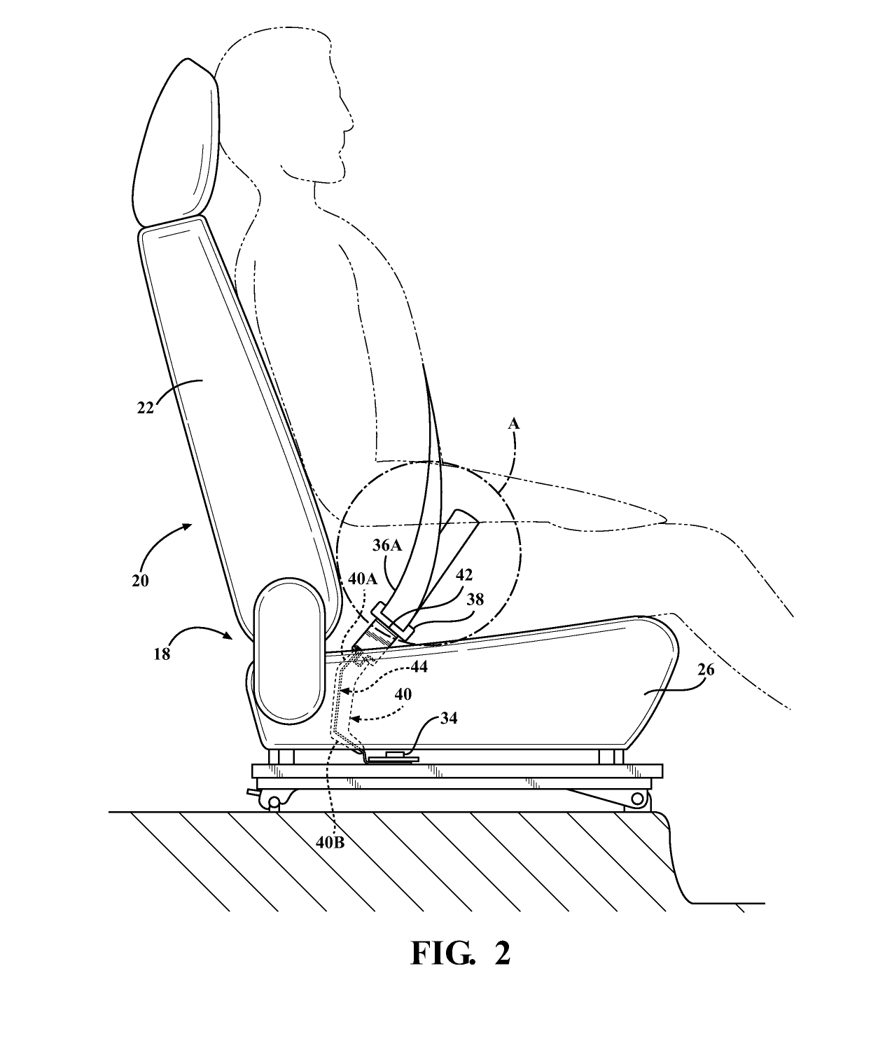

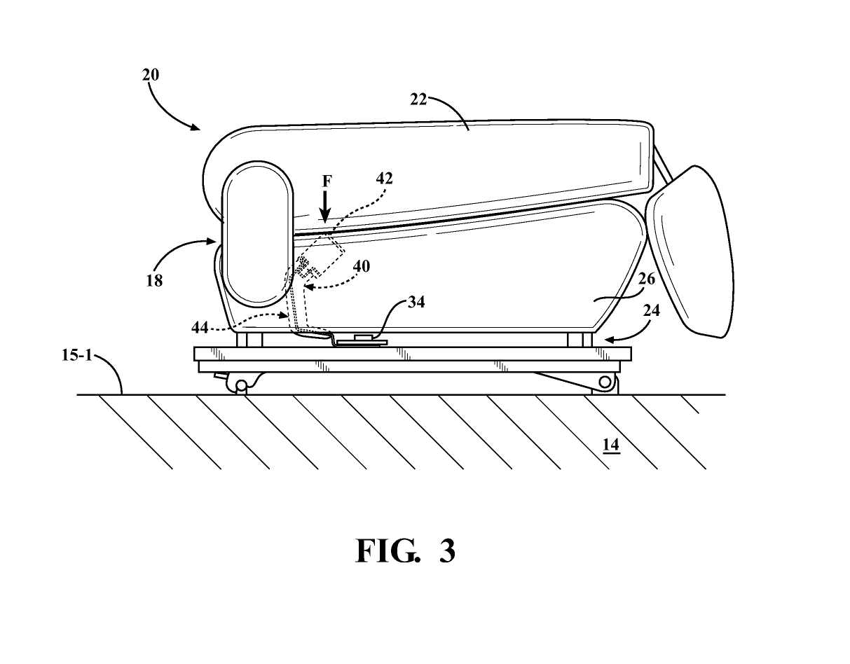

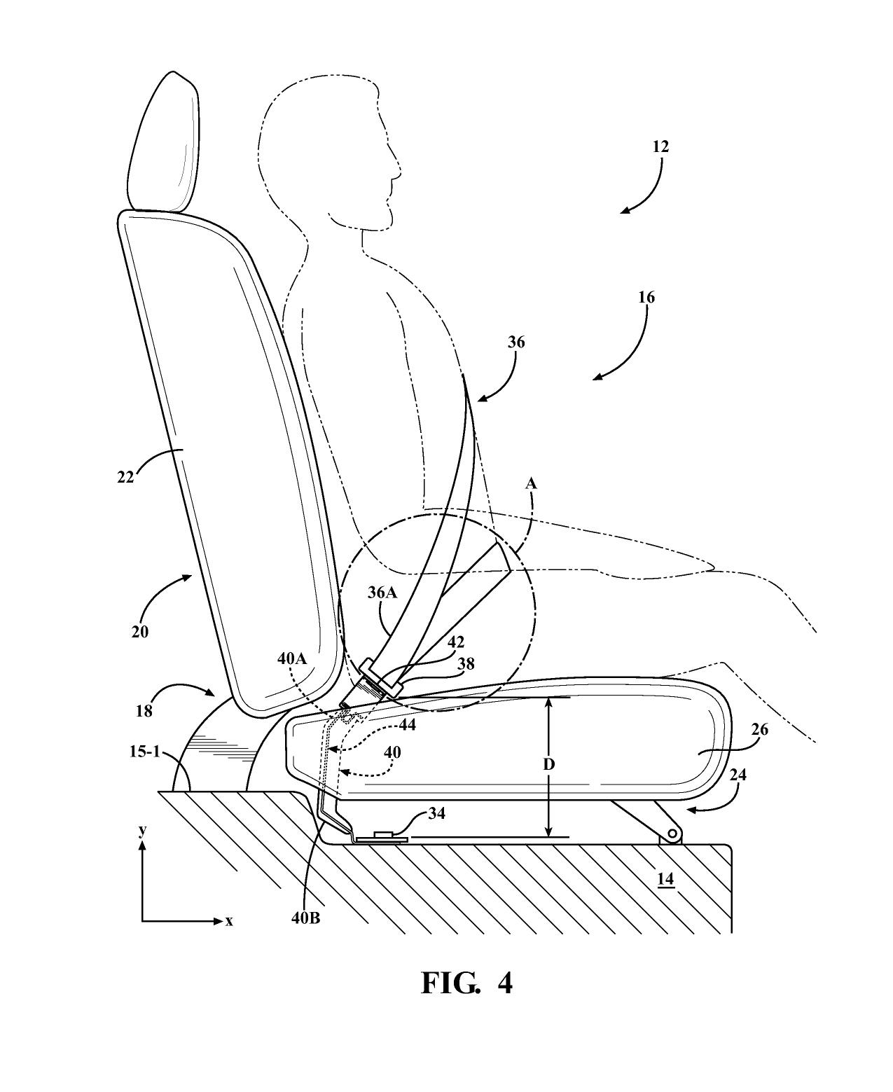

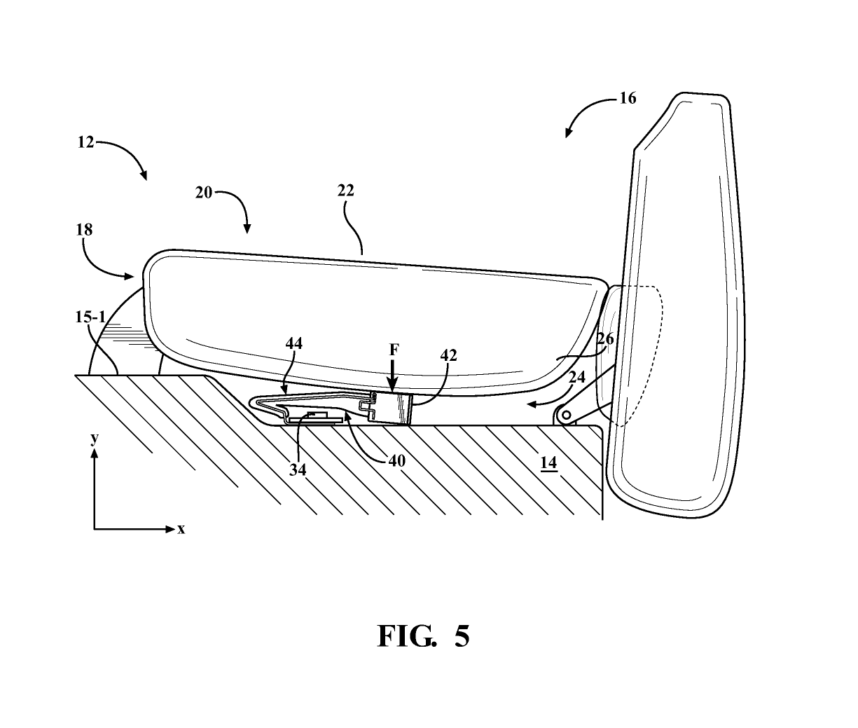

In FIGS. 1-5, the seat 16 is shown as a bench seat assembly positioned in a secondary row of the vehicle 12, such as second or third passenger row in a van or wagon body style. Alternatively, the seat 16 may be configured as a bucket seat and be positioned in a first row of the vehicle 12 that includes a location for the driver of the vehicle 12 (not shown). The seat 16 may be set up as a reconfigurable assembly, where the seatback 22 can fold flat relative to the cushion 26 (shown in FIGS. 2-3), and/or the entire seat assembly can be removed from and/or tumbled relative to the vehicle structure 14 about the first and second tracks 28, 30 (not shown). Such a reconfigurable seat 16 may also be set up to enable the cushion 26 to be tumbled relative to the vehicle structure 14, thus permitting the seatback 22 to fold substantially flat against or proximate to a floor 15-1 of the passenger compartment 15 (shown in FIGS. 4-5). As understood by those skilled in the art, such capability of the seat 16 to be reconfigured can significantly enhance cargo carrying capacity and overall utility of the vehicle 12.

The seatbelt system 10 is configured to provide a passive restraint for an occupant of the seat 16. The seatbelt system 10 includes a first anchor 32 and a second anchor 34, each connected to the vehicle structure 14. The first and second anchors 32, 34 may be fixed either directly to the vehicle structure 14 proximate the seat 16, such as to the floor 15-1 (shown in FIGS. 1 and 4-5), or indirectly, via the second seat structure 24 (shown in FIGS. 2-3). The seatbelt system 10 may additionally be anchored to structural pillars 15-2 of the passenger compartment 15, as shown in FIG. 1. As shown in the Figures, the seatbelt system 10 also includes a first belt 36. The first belt 36 includes a sash or shoulder belt 36A and a lap belt 36B, each typically made from a specialized high-strength fabric. The shoulder belt 36A is configured for being arranged around the torso of the occupant of the seat 16, while the lap belt 36B is configured for being arranged around the occupant's waist. The first belt 36 is slidably engaged with a first buckle element 38. Additionally, the first belt 36 is connected to the first anchor 32 via the lap belt 36B and thereby connects the first anchor to the first buckle element 38 for secure attachment of the first seatbelt to the vehicle structure 24.

The shoulder belt 36A is typically connected to a retractor-pretensioner (not shown) mounted to the vehicle structure 14 and is configured to selectively retract and tension the lap belt 36B. As understood by those skilled in the art, the retractor function of such a retractor-pretensioner permits some free movement of the seated occupant's upper torso, while the pretensioner function preemptively tightens the lap belt 36B and secures the occupant with respect to the seat 16 in the event of sudden acceleration or deceleration of the vehicle 12. Accordingly, as described above, the first belt 36 may be a retractable combination lap-shoulder belt.

As shown, the seatbelt system 10 also includes a second belt 40 that has a high-strength fabric section of a fixed length defined by a first end 40A and a second end 40B. The first end 40A includes a second buckle element 42, while the second end 40B is connected to the second anchor 34, thereby connecting the second buckle element to the second anchor via the second belt 40. The second buckle element 42 is complementary to the first buckle 38 element such that the first buckle element may be engaged with and fastened to the second buckle element, specifically to restrain the seated occupant. For example, the first buckle element 38 may be a male buckle element, in which case the second buckle element 42 would be a female buckle member designed to engage the first buckle member, or vice versa. Accordingly, when the first buckle 38 is fastened to the second buckle element 42 the seated occupant is securely restrained within the vehicle 12. Additionally, it is intended that the positioning of the first and second anchors 32, 34 “proximate” to the seat 16, as noted above, is such that the most direct path and the shortest possible length of the respective belts 36, 40 can be employed.

As may be seen in the Figures, the seatbelt system 10 additionally includes a buckle presenter 44 connecting the second buckle element 42 to the second anchor 34. As indicated by the name of the component, the buckle presenter 44 is configured to present the second buckle element 42 to the user of the seatbelt system 10, such as the occupant of the seat 16. The buckle presenter 44 supports the second buckle element 42 in each of the horizontal plane X and the vertical plane Y to thereby hold the second buckle element at a predetermined distance D from the second anchor 34. Specifically, the buckle presenter 44 is intended to position the second buckle element 42 consistently and reliably for convenient reach by the user.

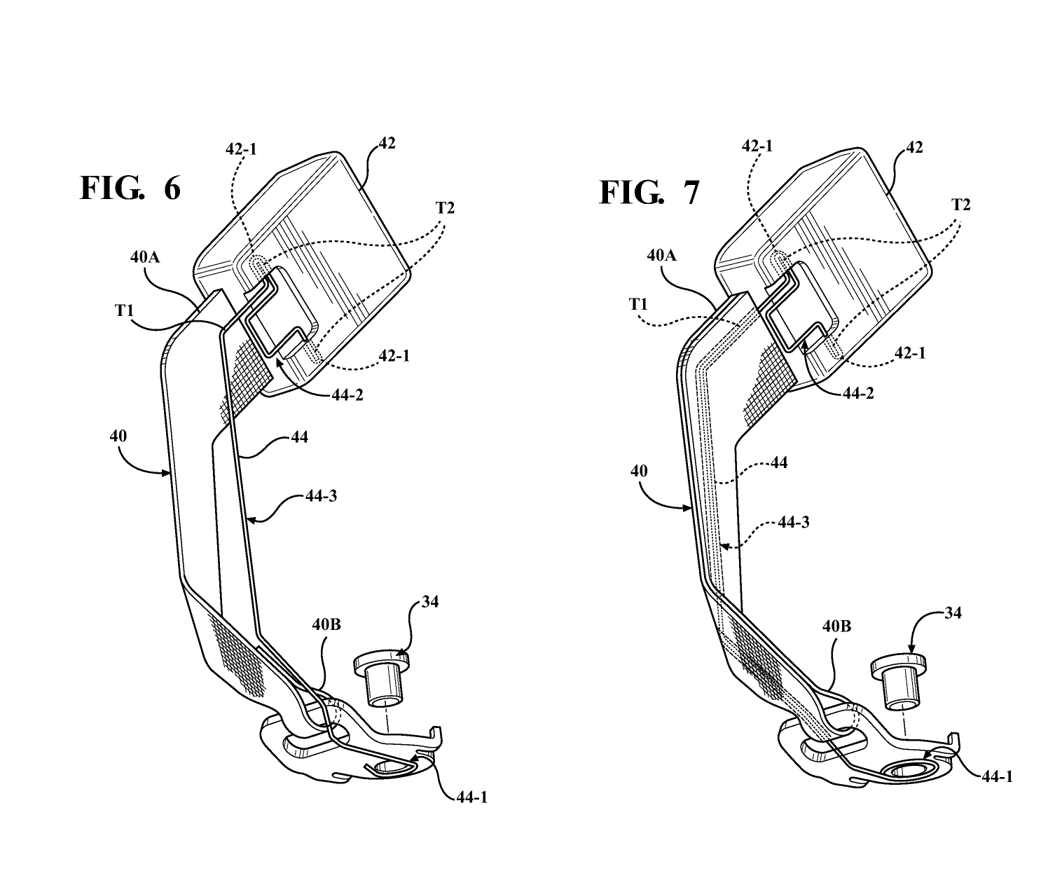

In order to achieve the stated objective of consistently positioning the second buckle element 42, the buckle presenter 44 is constructed from a resilient material. The buckle presenter 44 also has a free, i.e., static or unloaded, form or contour 46 (shown in FIGS. 6-7) that extends the second buckle element 42 into an area A proximate to the seated occupant near the cushion 26, as shown in FIGS. 2 and 4. The form 46 may vary under an applied force F, i.e., the buckle presenter 44 can bend or deflect when, for example, the buckle presenter has been trapped by the seatback 22 folded flat against the cushion 26. However, owing to the resilient nature of the buckle presenter 44, the original free form 46 will be recovered when the force F is removed, for example, when the buckle presenter has been unconstrained or released by the seatback 22 being unfolded from the cushion 26.

The buckle presenter 44 can be a tempered metal component, such as a spring steel wire. For example, the material for the buckle presenter 44 may be ASTM A227 cold drawn steel. In the case of a spring steel wire forming the buckle presenter 44, the buckle presenter can be constructed from a single continuous wire segment. As shown, the buckle presenter 44 includes a first end 44-1 configured to be fixedly retained by the second anchor 34, a distal second end 44-2 configured to be fixedly retained by the second buckle element 42, and an elongated body 44-3. To facilitate retention of the buckle presenter 44, the first end 44-1 may include either a hook (shown in FIG. 6) or a closed loop (shown in FIG. 7) shape that wraps around and is fastened to the vehicle structure 24 by the second anchor 34.

Additionally, as shown in FIGS. 6-7, the second end 44-2 of the buckle presenter 44 may include a “T” shape, i.e., the second end of the wire may be formed to resemble a shape of the letter “T”. The “T” shape is characterized by a long leg T1 and two short arms T2, wherein the elongated body 44-3 defines the long leg of the “T”, as shown in FIGS. 6-7. The resultant “T” shaped second end 44-2 can be employed to retain the buckle presenter 44 in the second buckle element 42 via the short arms T2 of the “T” being inserted into receptacle channels 42-1 in the second buckle element 42. The “T” shape may be formed from multiple successive bends in the case where the buckle presenter 44 is constructed from the single continuous wire segment. Other configurations of the second end 44-2 of the buckle presenter 44, such as a loop similar to the hook or loop as disclosed for the first end 44-1, are also envisioned.

It is envisioned that mainly the shape of the buckle presenter's elongated body 44-3 will vary under the applied force F and will then recover to its original form when the force is removed. While the force F is applied, the first and second ends 44-1, 44-2, on the other hand will remain in their substantially original shape for reliable retention of the buckle presenter 44 by the second anchor 34 and the second buckle element 42, respectively. The buckle presenter 44 and the second belt 40 may be separate components connected solely at the second buckle element 42 and at the second anchor 34, as shown in FIG. 6. In such an embodiment, the buckle presenter 44 can extend alongside the second belt 40.

Alternatively, the buckle presenter 44 may be integrated into the second belt 40, for example by having the buckle presenter threaded through or sewn into the fabric of the second belt, such that the buckle presenter 44 and the second belt 40 move and effectively operate as a single unit, as shown in FIG. 7. Accordingly, in the case where the buckle presenter 44 is integrated into the second belt 40, the integrated buckle presenter 44 and second belt 40 will deflect together under the application of force F and then subsequently recover. Overall, in each of the disclosed embodiments, the buckle presenter 44 may span the distance between the second anchor 34 and the second buckle element 42 along with the fabric section of the second belt 40.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A seatbelt system for a vehicle having a vehicle structure and a seat operatively connected to the vehicle structure, the seatbelt system comprising:
a first anchor and a second anchor, each connected to the vehicle structure;
a first buckle element and a complementary second buckle element, wherein the first buckle element is configured to engage the second buckle element and fasten thereto;
a first belt connecting the first anchor to the first buckle element;
a second belt connecting the second buckle element to the second anchor; and
a buckle presenter constructed from a spring steel wire, connecting the second buckle element to the second anchor and having a form configured to present the second buckle element to a user of the seatbelt system, wherein the form varies under an applied force and recovers when the force is removed.

2. The seatbelt system of claim 1, wherein the buckle presenter includes a first end configured to be fixedly retained by the second anchor and a second end configured to be fixedly retained by the second buckle element.

3. The seatbelt system of claim 2, wherein the first end of the buckle presenter includes one of a hook and a loop.

4. The seatbelt system of claim 2, wherein the second end of the buckle presenter includes a “T” shape.

5. (canceled)

6. The seatbelt system of claim 1, wherein the spring steel wire is a single continuous wire segment.

7. The seatbelt system of claim 1, wherein the buckle presenter is integrated into the second belt.

8. The seatbelt system of claim 1, wherein the buckle presenter and the second belt are separate components connected solely at the second buckle element and the second anchor.

9. A vehicle comprising:
a vehicle structure;
a seat operatively connected to the vehicle structure; and
a seatbelt system having:
a first anchor and a second anchor, each connected to the vehicle structure;
a first buckle element and a complementary second buckle element, wherein the first buckle element is configured to engage the second buckle element and fasten thereto;
a first belt connecting the first anchor to the first buckle element;
a second belt connecting the second buckle element to the second anchor; and
a buckle presenter constructed from a spring steel wire, connecting the second buckle element to the second anchor and having a form configured to present the second buckle element to a user of the seatbelt system, wherein the form varies under an applied force and recovers when the force is removed.

10. The vehicle of claim 9, wherein the buckle presenter includes a first end configured to be fixedly retained by the second anchor and a second end configured to be fixedly retained by the second buckle element.

11. The vehicle of claim 10, wherein the first end of the buckle presenter includes one of a hook and a loop.

12. The vehicle of claim 10, wherein the second end shape of the buckle presenter includes a “T” shape.

13. (canceled)

14. The vehicle of claim 9, wherein the spring steel wire is a single continuous wire segment.

15. The vehicle of claim 9, wherein the buckle presenter is integrated into the second belt.

16. The vehicle of claim 9, wherein the buckle presenter and the second belt are separate components connected solely at the second buckle element and the second anchor.

17. A buckle presenter for a vehicle seatbelt system having a belt connected to a vehicle structure via an anchor and a buckle element connected to the belt, the buckle presenter comprising:
a resilient elongated body constructed from a spring steel wire;
a first end configured to be fixedly retained by the anchor; and
a distal second end configured to be fixedly retained by the buckle element;
wherein:
the resilient elongated body is defined by a form configured to support the buckle element in horizontal and vertical planes and hold the buckle element at a predetermined distance from the anchor; and
the form varies under an applied force and recovers when the force is removed.

18. The seatbelt system of claim 17, wherein:
the first end of the buckle presenter includes one of a hook and a loop; and
the second end of the buckle presenter includes a “T” shape.

19. The seatbelt system of claim 17, wherein the buckle presenter is integrated into the belt.

20. The seatbelt system of claim 17, wherein the buckle presenter and the belt are separate components connected solely at the buckle element and the anchor.
